(19) United States
(12) Patent Application Publication
(10) Pub. No.: US 2005/0116833 A1
(43) Pub. Date: Jun. 2, 2005

(54) Bridge damage detection system and method

(76) Inventor: Patricia A. Miller, Huntsville, AL (US)

Correspondence Address: LANIER FORD SHAVER & PAYNE, P O BOX 2087, HUNTSVILLE, AL, 35804, US

(21) Appl. No.: 10/725,020

(22) Filed: Dec. 1, 2003

(51) Int. Cl. G08B 21/00

(52) U.S. Cl. 340/690; 340/686.2; 340/652

(57) ABSTRACT

In one embodiment, a bridge damage detection system comprises a first conductor and a second conductor suitable for carrying electric current, the first and second conductors suitable for running along a first section of a bridge. The system also comprises a junction box affixed to the first section of the bridge, the junction box coupling a first end of the first conductor and a first end of the second conductor. The system further comprises a control panel coupled to a distal end of the first conductor and a distal end of the second conductor, the control panel being operable to provide an electric current on the first conductor and to monitor the second conductor for an expected return electric current, the control panel being operable to transmit a signal to activate a notification device upon failing to detect the return electric current on the second conductor.

### BACKGROUND

1. Field

The present invention relates generally to the field of structural damage detection and, in particular, to a system and method for detecting damage to a bridge or similar spanning structure.

2. Description of the Related Art

Unfortunately, many catastrophes involve bridges and other such spanning structures such as highway or roadway overpasses when the structural integrity or condition of the structure has been compromised. For example, the integrity of a bridge may be compromised as a result of impacts from ships, barges, trucks, tractor trailers, earth moving equipment, and the like. The compromise to the structural integrity and condition of the bridge typically remains undetected until the bridge fails under loading from, for example, a train, automobile, truck, etc., passing over the bridge at a subsequent period in time. The damage to or the compromised condition of the bridge is only detected when investigating the likely cause of the catastrophe.

Natural forces may also compromise the integrity of the structures. For example, in areas such as California, an earthquake may structurally compromise a bridge to a point where a catastrophe does not occur until the bridge is subsequently utilized. In Florida and along the eastern seaboard of the United States, a hurricane may damage a bridge to the point where the bridge does not collapse until the bridge is utilized at a later point in time.

When a bridge is structurally compromised to where it is likely to cause a catastrophe when subsequently used, it is desirable to detect and adequately warn of the damage to the bridge. For example, a train crossing a structurally compromised railroad bridge may derail and plunge into the water or ground below the bridge. In another example, a structurally compromised roadway overpass may collapse at an unexpected point in time due to successive loading from vehicles passing over the overpass. The warning can alert approaching users of the bridge of the compromised condition of the bridge and, thus, prevent a potential catastrophe.

### SUMMARY

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a bridge damage detection system comprises a first conductor and a second conductor suitable for carrying electric current, the first and second conductors suitable for running along a first section of a bridge, a junction box affixed to the first section of the bridge, the junction box coupling a first end of the first conductor and a first end of the second conductor, and a control panel coupled to a distal end of the first conductor and a distal end of the second conductor, the control panel being operable to provide an electric current on the first conductor and to monitor the second conductor for an expected return electric current, the control panel being operable to transmit a signal to activate a notification device upon failing to detect the return electric current on the second conductor.

In another embodiment, a method for monitoring a spanning structure for damage comprises running a first conductor along a first section of a spanning structure, the first conductor suitable for carrying electric current, running a second conductor along the first section of the spanning structure, the second conductor suitable for carrying electric current, coupling a first end of the first conductor and a first end of the second conductor, supplying an electric current to a distal end of the first conductor, monitoring the distal end of the second conductor for an expected return electric current, and responsive to failing to detect the expected return electric current at the distal end of the second conductor, activating a notification device.

In still another embodiment, a spanning structure damage detection and warning system comprises a means for providing a closed circuit along a section of a spanning structure, a means for supplying an electric current on the closed circuit, a means for detecting a break in the closed circuit, and a means for activating a notification device upon detecting the break in the closed circuit.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The following drawings incorporated in and forming a part of the specification illustrate, and together with the detailed description serve to explain the various aspects of the implementation(s) and/or embodiments of the invention and not of the invention itself.

FIG. 1 illustrates a block diagram of exemplary components of a bridge damage detection system, according to the present invention.

FIG. 2 illustrates a side view of a portion of a bridge to which the bundle of wires is attached, according to one embodiment of the present invention.

FIG. 3 illustrates a top view of a bridge to which the bundle of wires is attached along both sides of the bridge, according to one embodiment of the present invention.

### DETAILED DESCRIPTION

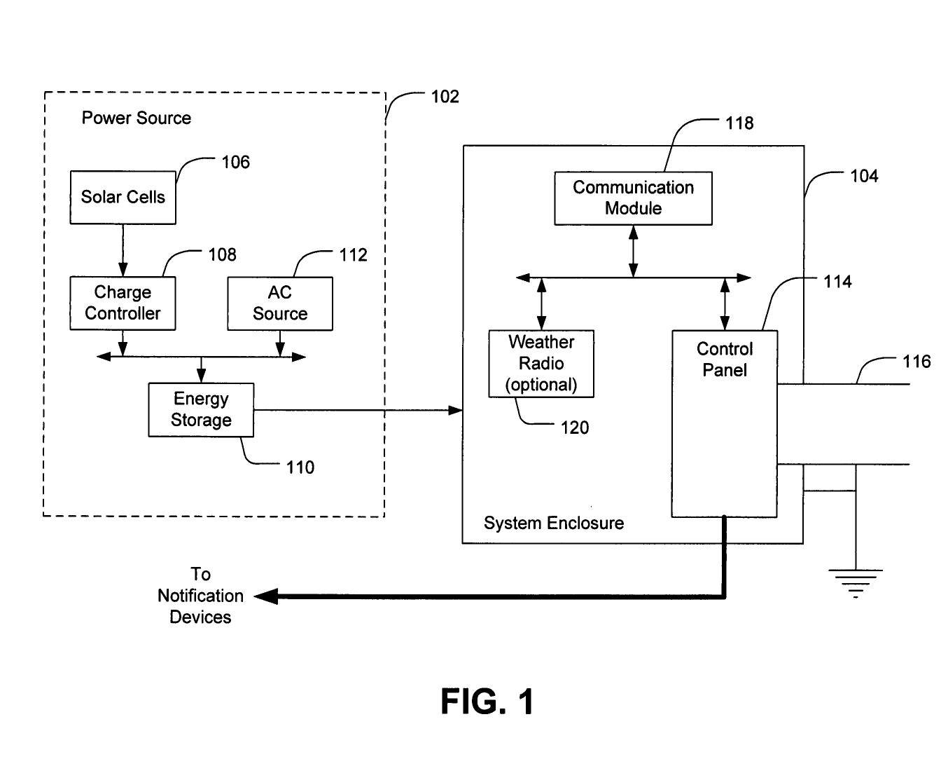

The various embodiments of the present invention and their advantages are best understood by referring to FIGS. 1 through 3 of the drawings. The elements of the drawings are not necessarily to scale, emphasis instead being placed upon clearly illustrating the principles of the invention. Throughout the drawings, like numerals are used for like and corresponding parts of the various drawings.

The drawings represent and illustrate examples of the various embodiments of the invention, and not a limitation thereof. It will be apparent to those skilled in the art that various modifications and variations can be made in the present invention without departing from the scope and spirit of the invention as described herein. For instance, features illustrated or described as part of one embodiment can be included in another embodiment to yield a still further embodiment. Moreover, variations in selection of materials and/or characteristics may be practiced to satisfy particular desired user criteria. Thus, it is intended that the present invention covers such modifications as come within the scope of the present features and their equivalents.

Furthermore, reference in the specification to “an embodiment,” “one embodiment,” “various embodiments,” or any variant thereof, means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

FIG. 1 illustrates a block diagram of exemplary components of a bridge damage detection system, according to the present invention. The bridge damage detection system comprises a power source 102 coupled to a system enclosure 104. In general, power source 102 supplies power (i.e., electricity) to the components of the bridge damage detection system in order to enable the bridge damage detection system to provide warnings to, for example, motorists, the proper authorities, as well as other interested persons in the event that a bridge, overpass or other such spanning structure becomes damaged. By way of example, the damage may be to a guard rail, deck or column that supports the bridge or overpass, which is caused by a wreck and/or an accident involving a motor vehicle, watercraft or a train, an act of nature, or an act of terrorism. As used herein, the terms “connected,” “coupled,” or any variant thereof, means any connection or coupling, either direct or indirect, between two or more elements; the coupling or connection between the elements can be physical, logical, or a combination thereof.

As depicted in FIG. 1, power source 102 comprises a solar cell(s) 106, a charge controller 108, an energy storage 110, and an AC source 112. Solar cell(s) 106 generally functions to convert sunlight into electricity. In one embodiment, solar cell(s) 106 comprises one or more photovoltaic cells or modules that are typically made of semiconductors, such as silicon. As is generally known by those of ordinary skill in the relevant art, photovoltaic cells directly convert sunlight into electricity by absorbing some of the light that strikes the cell within the semiconductor material, which frees the electrons, and drawing the electrical current that is created by the directional flow of the freed electrons for use externally.

Solar cell(s) 106 is coupled to charge controller 108. In particular, the electrical current provided by solar cell(s) 106 is provided as an input to charge controller 108. Charge controller 108 is coupled to energy storage 110, and generally functions to prevent overcharging of energy storage 110. Charge controller 108 also maintains the electrical charge in energy storage 110 by preventing the electrical charge stored in energy storage 110 from discharging to, for example, solar cell(s) 106 at night.

Energy storage 1 10 generally functions to store the electrical charge being generated by solar cell(s) 106. In one embodiment, energy storage 110 comprises at least one rechargeable battery that functions as a DC voltage source that provides electrical power to the components of the bridge damage detection system and, in particular, the components housed in system enclosure 104.

AC source 112 is coupled to energy storage 110, and is a commercial alternating power (AC) source such as that provided by a utility company. In this instance, AC source 112 comprises wires and circuitry necessary to connect to and receive or draw electricity from the utility company, and functions to charge energy source 110. As is generally known to one of ordinary skill in the art, a converter that converts AC to direct current (DC) may be necessary if AC source 112 is AC and the coupled energy source 110 is DC.

In another embodiment, AC source 112 may function as an alternate source of electrical power, in addition to energy storage 110. For example, power source 102 can include components (not depicted) that function to determine whether energy storage 110 or AC source 1 12 is to provide the electrical power to system enclosure 104. For example, if energy storage 110 is detected to have insufficient stored electrical energy, the aforementioned components can cause AC source 112 to provide electrical power to system enclosure 104. Conversely, if energy storage 110 is detected to have sufficient stored electrical energy, the aforementioned components can cause energy storage 110 to provide electrical power to system enclosure 104.

In still another embodiment, AC source 112 may be optional and not provided, for example, in geographic areas where AC power is difficult to obtain. In yet other embodiments, power source 102 may include components that draw electrical power provided by wind and/or waterpower systems. It will be appreciated that any combination of the power sources (i.e., solar, wind, water, commercial AC, etc.) can be coupled to and charge energy storage 110. Moreover, any one of the power sources may function as an additional alternate power source to system enclosure 104. By way of example, in one embodiment, instead of solar cell(s) 106, power source 102 may comprise components that draw electrical power from a wind turbine (not depicted), which in turn is used to charge energy storage 110.

System enclosure 104 comprises a control panel 114, a conduit 116, a communication module 118, and an optional weather radio 120. Control panel 114 generally functions to monitor a bridge for damage and, upon detecting damage to the bridge, functions to alert potential users of the bridge of the damage to the bridge. Control panel 114 utilizes a plurality of electric circuits to monitor sections of the bridge in order to detect damage to the bridge. Control panel 114 may comprise a microcontroller, microprocessor or processor and memory for the storage and execution of program logic or other substrate configuration representing data and instructions, which cause the bridge damage detection system to operate in a specific and predefined manner as, described herein.

In one embodiment, system enclosure 104 is a weather and corrosion proof enclosure, such as, by way of example and not limitation, a stainless steel weather and corrosion proof enclosure conforming to the National Electrical Manufacturers Association (NEMA) 3r, 4 or 12 standard. System enclosure 104 and conduit 116 is appropriately grounded.

In one embodiment, a plurality of conductors carry a flow of electric current to create the plurality of electric circuits. The plurality of conductors, such as, by way of example and not limitation, a bundle of 18 gauge copper wires, are run from control panel 114 along sections of the bridge through conduit 116. Each of the wires in the bundle of wires is coupled at one end to control panel 114. At various places along the bridge, two of the wires in the bundle of wires are coupled to each other, thus, creating a closed circuit when the opposite ends of these two wires are coupled at control panel 114.

It will be appreciated that the size and type of conductor may vary depending on factors such as the length of the conductor (i.e., circuit), the current that is carried on the conductor, and the like.

At control panel 114, an electric current can be supplied to one of the two wires that form a closed circuit. The other wire in the closed circuit can be monitored for the expected return electric current. If the circuit is broken for any reason (i.e., damage to the respective section of the bridge being monitored by the closed circuit), control panel 114 transmits a signal, which is used to generate warnings that inform of the damage to the bridge.

In one embodiment, conduit 116, which houses the bundle of wires and runs along sections of the bridge, may be composed of a series of solid conduits and flexible conduits. Conduit 116 is a solid conduit when run along physical (i.e., material, tangible, etc.) portions or sections of the bridge. As is generally known, the physical sections or portions of the bridge typically expand and contract depending on factors such as temperature. Thus, bridges typically have expansion joints to accommodate the expansion and contraction of the physical sections or portions of the bridge. When run along sections of the bridge where periodic expansion and/or contraction is expected to occur, conduit 116 is (i.e., becomes or converts to) a flexible conduit.

The solid conduit is of a characteristic that when the section of the bridge to which the solid conduit is affixed is damaged, the wires within the solid conduit become severed, damaged, or sufficiently extended, and the wires no longer able to carry the electric current in a closed circuit. Conversely, the flexible conduit is of a characteristic as to permit expansion and contraction without inhibiting the flow of electric current in a closed circuit. Notwithstanding the flexible characteristic of the flexible conduit, the flexible conduit and the wires housed within the flexible conduit will become severed, damaged, or sufficiently extended, and the wires no longer able to carry the electric current in the closed circuit if the flexible conduit is extended/contracted beyond the expansion/contraction that normally occurs at a typical bridge expansion joint. The typical expansion/contraction that occurs at a bridge expansion joint is approximately between one to two inches (1″-2″).

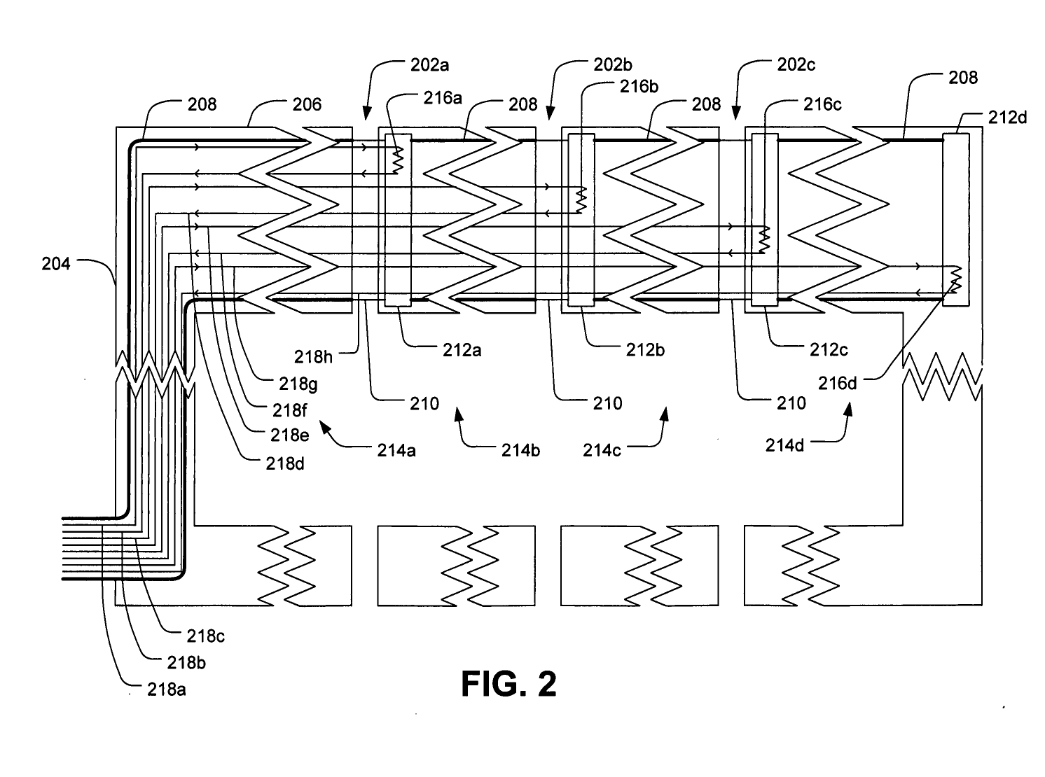

FIG. 2 illustrates a side view of a portion of a bridge to which the bundle of wires is attached, according to one embodiment of the present invention. By way of example, the bridge is illustrated as having three expansion joints 202a, 202b, 202c, and the bundle of wires is run from system enclosure 104 (see FIG. 1) up the side of a bridge abutment 204 and along the side of a bridge rail 206. Along physical sections of the bridge (i.e., bridge abutment 204 and bridge rail 206), the bundle of wires are run through solid conduit 208, which is affixed to the bridge using fasteners suitable for affixing solid conduit 208 to the bridge. When a portion of the physical section of the bridge to which solid conduit 208 is sufficiently damaged, solid conduit 208 and the wires within solid conduit 208 becomes damaged (i.e., severed or broken) and no longer able to support the flow of electric current.

At proximately the beginning of each expansion joint 202a, 202b, 202c, solid conduit 208 converts to flexible conduit 210, which spans each expansion joint 202a, 202b, 202c. Thus, over expansion joint 202a, 202b, 202c, the bundle of wires are run through flexible conduit 210. Flexible conduit 210 is of a characteristic as to be able to withstand the contraction and expansion that occurs at each expansion joint 202a, 202b, 202c. When flexible conduit 210 is sufficiently extended beyond the normally expected expansion at each expansion joint 202a, 202b, 202c, flexible conduit 210 and the wires within flexible conduit 210 becomes damaged (i.e., severed or broken) and no longer able to support the flow of electric current.

Solid conduit 208 and flexible conduit 210 are conventional rigid and flexible conduits that are readily available from conduit and fittings manufacturers such as Bridgeport Fittings, Inc. of Stratford, Conn. As is generally known in the art, one or more readily available conduit fittings, also available from conduit and fittings manufacturers such as Bridgeport Fittings, Inc. of Stratford, Conn., are generally utilized to couple solid conduit 208 and flexible conduit 210

A plurality of junction boxes 212a, 212b, 212c, 212d are affixed to the side of the bridge and used to create the plurality of electric circuits that are used to monitor the bridge for damage. In one embodiment, the bridge can be separated into “zones” that are monitored for damage. Each zone is monitored by at least one electric circuit extending from control panel 114. By way of example and as illustrated in FIG. 2, junction box 212a is affixed to bridge rail 206 proximately near expansion joint 202a (i.e., just past expansion joint 202a). Similarly, junction box 212b is affixed to bridge rail 206 just past expansion joint 202b, and junction box 212c is affixed to bridge rail 206 just past expansion joint 202c. Junction box 212d is affixed to bridge rail 206 at proximately the distal end opposite the end to which junction box 212c is affixed.

Positioning junction boxes 212a, 212b, 212c, in this manner creates four zones 214a, 214b, 214c, 214d, that extend along bridge abutment 204 and bridge rail 206. In particular, zone 214a is substantially comprised of bridge abutment 204 and the section of bridge rail 206 up to expansion joint 202a, zone 214b is substantially comprised of the section of bridge rail 206 extending from expansion joint 202a to expansion joint 202b, zone 214c is substantially comprised of the section of bridge rail 206 extending from expansion joint 202b to expansion joint 202c, and zone 214d is substantially comprised of the section of bridge rail 206 extending from expansion joint 202c to the distal end of bridge rail 206.

Moreover, positioning junction boxes 212a, 212b, 212c, in this manner (i.e., proximately near expansion joints 202a, 202b, 202c, enables flexible conduit 210 to be coupled to junction boxes 212a, 212b, 212c. Alternatively, if any one of junction boxes 212a, 212b, 212c, is positioned a sufficient distance away from its respective expansion joint 202a, 202b, 202c, flexible conduit 210 is converted to solid conduit 208, and solid conduit 208 is then coupled to its respective junction box 212a, 212b, 212c, which is positioned away from its respective expansion joint 202a, 202b, 202c.

As illustrated in FIG. 2, flexible conduit 210 spans each expansion joint 202a, 202b, 202c, and is coupled to one side of junction box 212a, 212b, 212c, respectively. Solid conduit 208 is coupled to the other side of junction box 212a, 212b, and extends to expansion joint 202b, 202c, respectively. Solid conduit 208 is also coupled to the other side of junction box 212c and extends to and is coupled to one side of junction box 212d. In this manner, the bundle of wires extend from control panel 114 and along the length of bridge abutment 204 and bridge rail 206 through a series of solid conduits 208, flexible conduits 210 and junction boxes 212a, 212b, 212c, 212d.

In one embodiment, each junction box 212a, 212b, 212c, 212d comprises a resistor 216a, 216b, 216c, 216d, respectively, suitable for coupling two of the wires in the bundle of wires to create a closed circuit back at control panel 114. Resistor 216a, 216b, 216c, 216d, is a 1,000 ohm resistor. It will be appreciated that different valued resistors (i.e., other than 1,000 ohms) may be used to couple the pair of wires, and the value of the resistor used may depend on the amount of resistance desired in the electric circuit.

By way of example and as is illustrated in FIG. 2, wires 218a-h extend from control panel 114 through solid conduit 208 and flexible conduit 210 to junction box 212a. In junction box 212a, wires 218a, 218b, are each coupled to a respective end of resistor 216a. The other end of wires 218a, 218b, can then be coupled at control panel 114 to create a closed circuit suitable for carrying electric current used to monitor the condition of zone 214a. The remaining wires 218c-h pass through junction box 212a to subsequent junction box 212b, where wires 218c, 218d, are each coupled to a respective end of resister 216b, while the remaining wires 218e-h pass through junction box 212b to subsequent junction box 212c. The other end of wires 218c, 218d, can then be coupled at control panel 114 to create a closed circuit suitable for carrying electric current used to monitor the condition of zone 214b. In a similar fashion, wires 218e, 218f, are each coupled to resistor 216c in junction box 212c, and wires 218g, 218h, are each coupled to resistor 216d injunction box 212d.

It will be appreciated that the wiring illustrated in FIG. 2 provides a degree of redundant monitoring capability. For example, the closed circuit (i.e., the pair of wires) used to monitor zone 214b also monitors 214a. Similarly, the closed circuit used to monitor zone 214c also monitors zones 214a, 214b, and the closed circuit used to monitor zone 214d also monitors zones 214a, 214b, 214c.

Referring again to FIG. 1, for each pair of wires used to create the closed circuit, control panel 114 provides an electric current on one of the wires used to create the closed circuit and monitors the other wire for the expected return current. For example, control panel 114 can provide an electric current on wires 218a, 218c, 218e, 218g, and monitor wires 218b, 218d, 218f, 218h, for the expected return current. In the event that a section of the bridge (i.e., zone) being monitored by the electric circuits is damaged, the continuity of the wires that carry the electric current that is used to monitor the damaged section of the bridge will be broken, creating what is generally known as an open circuit. Control panel 114 monitors wires 218b, 218d, 218f, 218h, to detect an open circuit.

In one embodiment, upon detecting an open circuit, control panel 114 transmits a signal to activate at least one notification device, such as, by way of example and not limitation, a signboard, an audible alarm device, a warning light, a drop bar, and the like, to warn of the damage to the bridge. For example, control panel 114 may activate a signboard positioned at one or both ends of the bridge to display a predetermined message alerting potential users of the potential danger in using the damaged bridge. Control panel 114 may also active warning lights, cause the audible alarm device to emit an audible message or tone, and/or lower a drop bar in order to warn of the damage to the bridge.

In one embodiment, control panel 114 activates communication module 118 to notify a central operator, typically located at a remote location, of the damage to the bridge. Communication module 118 generally functions to provide communication capability utilizing one or more suitable communication technologies such as, by way of example and not limitation, wired communication, wireless communication, cellular communication, satellite communication, radio communication, and the like. Thus, communication module 118 may comprise a traditional telephone, a cellular phone, a satellite phone, a two-way radio, or any other communication device capable of communicating with a compatible communication device that is accessible by the central operator. For example, control panel 114 activates communication module 118 to connect to the central operator's communication device and transmits notification of the damage to the bridge. The notification may identify the damaged bridge and may include the location of the damaged bridge and/or a description of the damage.

The notification may be in the form of a signal or sequence of signals that is transmitted and understood to be a notification of damage to the bridge. For example, the notification may be a warning message that is transmitted to and displayed on the central operator's communication device (i.e., a monitor). The notification may also be an audible warning (i.e., tone(s) or a message) that is transmitted to and emitted by the central operator's communication device. The notification may additionally be a signal that activates one or more lights on, for example, a control panel, that is visually accessible to the central operator. Having received notification of the damaged bridge, the central operator can in turn notify the proper emergency personnel of the damage to the bridge.

It will be appreciated that in various embodiments of the present invention, communication module 118 can include one or more suitable communication devices.

By way of example and not limitation, communication module 118 can include both a primary communication device capable of communicating via cellular communication and a secondary or backup communication device capable of communicating via satellite communication. In this instance, communication module 118 can use the primary communication device to communicate the damage to the central operator and, in the event the primary communication device fails to operate properly, the secondary communication device can be used to communicate the damage.

In another embodiment, the central operator may be able to remotely activate the notification device to warn potential users of the damage to the bridge. For example, the central operator may remotely program the signboard, operate a signboard to display an appropriate message, active warning lights, emit an audible message or tone, and/or lower a drop bar in order to warn of the damage to the bridge and the potential dangers of using the damaged bridge.

In still another embodiment, alarm panel 114 may be activated by an optional weather radio 120. Weather radio 120 is a National Oceanic and Atmospheric Administration (NOAA) compatible weather radio or other comparable device suitable for receiving severe weather warnings, such as, by way of example and not limitation, a tornado warning, a flood warning, an ice warning, and the like. Upon receiving a weather warning, weather radio 120 activates alarm panel 114 to transmit a signal to appropriately activate at least one of the aforementioned notification devices. For example, alarm panel 114 can display one of a number of predetermined messages on the signboard to notify motorists of the severe weather warning in the area of the bridge, allowing the motorist to be weather conscience. Alarm panel 114 can also utilize communication module 118 to appropriately notify the central operator of the severe weather warning in the area of the bridge.

In a further embodiment, control panel 114 may comprise control and/or program logic configured to transmit a “trouble” alarm or notification to, for example, the central operator when it senses that there is something wrong with any part of the bridge damage detection system. For example, control panel 114 can periodically monitor the various components of the bridge damage detection system, including system enclosure 104 and the ground wire. Upon detecting a fault or failure (including tampering), control panel 114 can utilize communication module 118 to notify a predetermined person(s) of the detected fault or failure.

In a still further embodiment, control panel 114 may comprise control and/or program logic to enable remote testing of the bridge damage detection system. For example, authorized personnel can remotely connect to the bridge damage detection system and perform various functions such as, by way of example and not limitation, program control panel 114 and/or various other components of the bridge damage detection system, perform diagnostic operations to determine the condition of bridge damage detection system, request diagnostic information regarding the condition/status/operating history of the bridge damage detection system, etc.

One of ordinary skill in the art will appreciate that the depicted components and/or modules are only exemplary and that the functionality provided for in the components and/or modules may be combined into fewer components and/or modules or further separated into additional components and/or modules. In some embodiments, one or more of the functions provided by the modules and/or components may be optional and not implemented or present.

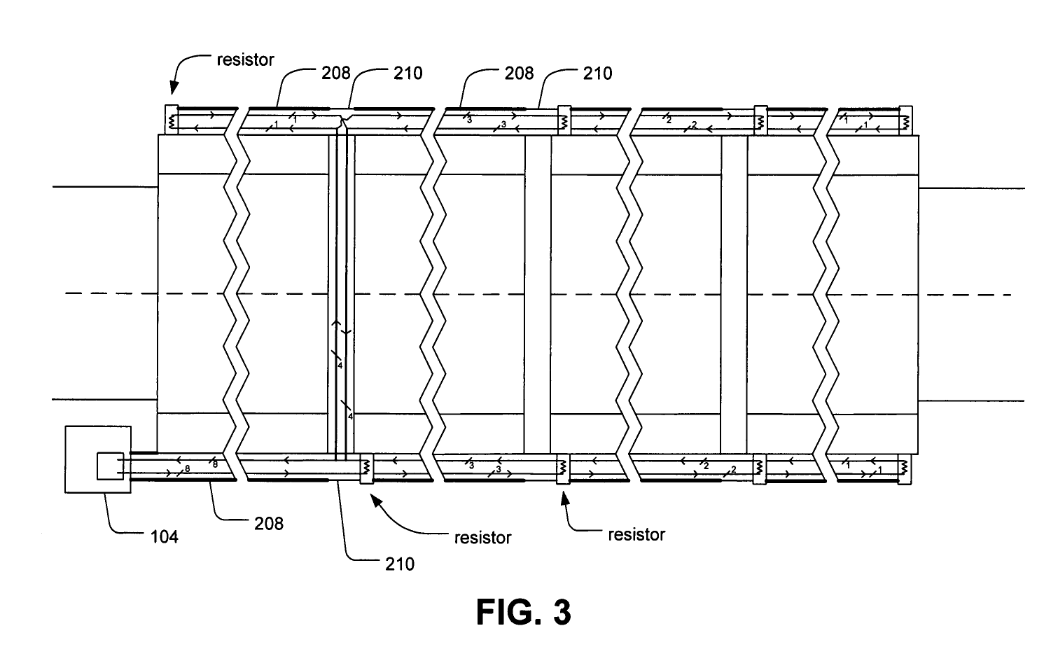

In another embodiment, the bundle of wires is run from control panel 114 along sections of both sides of a bridge. FIG. 3 illustrates a top view of a bridge to which the bundle of wires is attached along both sides of the bridge, according to one embodiment of the present invention. By way of example, the bridge is illustrated as having three expansion joints, and the bundle of wires extends from system enclosure 104. Some of the wires run down one side of the bridge (i.e., the side of the bridge to which system enclosure 104 is attached), while other wires run to and extend down the opposite side of the bridge.

As previously noted, the wires are housed in a solid conduit when they are run along physical sections of the bridge, and housed in a flexible conduit when the wires are run along sections of the bridge where expansion and/or contraction is expected to occur. Moreover, the wires extending from one side of the bridge to the other side of the bridge may be run in a conduit that is located, by way of example, under the deck of the bridge or in any one of the expansion joints in the bridge. The wires can also be run in an underground conduit located at either end of the bridge or encased in the bridge concrete on either end.

In still another embodiment, a plurality of system enclosures 104 may be used to monitor a bridge. For example, a first system enclosure 104 may be used to monitor a first side of the bridge and a second system enclosure 104 may be used to monitor a second (i.e., opposite) side of the bridge. In another example, a first system enclosure 104 may be used to monitor a first part or section of the bridge, a second system enclosure 104 may be used to monitor a second part or section of the bridge, and so on.

It will be appreciated that the bridge damage detection system may be used to monitor any part or section of a bridge to which the conduit housing the wires can be adequately affixed. The conduit can be affixed to a guard rail on the side of the bridge, the deck of the bridge (i.e., the upper side of the deck, side of the deck and/or bottom side of the deck), the column supporting the bridge, and any combination thereof, which enables the bridge damage detection system to monitor and report damage to the guard rail, deck or any column of the bridge. In certain instances, for example, during new construction of a bridge, the conduit can be run inside certain parts of the bridge (i.e., inside the guard rail, inside the column, inside the side of the deck, etc.). It will also be appreciated that the bridge damage detection system may be used to monitor only selected sections of the bridge.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

1. A bridge damage detection system comprising:
a first conductor and a second conductor suitable for carrying electric current, the first and second conductors suitable for running along a first section of a bridge;
a junction box affixed to the first section of the bridge, the junction box coupling a first end of the first conductor and a first end of the second conductor; and
a control panel coupled to a distal end of the first conductor and a distal end of the second conductor, the control panel being operable to provide an electric current on the first conductor and to monitor the second conductor for an expected return electric current, the control panel being operable to transmit a signal to activate a notification device upon failing to detect the return electric current on the second conductor.

2. The system of claim 1 further comprising a conduit that houses the first and second conductors, the conduit suitable for being run along the first section of the bridge, the conduit being a solid conduit when run along a physical portion of the first section of the bridge, the conduit being a flexible conduit when run along a portion of the first section of the bridge where expansion or contraction is expected to occur.

3. The system of claim 1, wherein the junction box comprises a resistor, the resistor coupling the first end of the first conductor and the first end of the second conductor.

4. The system of claim 1, wherein the first conductor and the second conductor are each an 18 gauge copper wire.

5. The system of claim 1, wherein the notification device is a signboard being operable to display a message alerting of damage to the bridge.

6. The system of claim 1, wherein the notification device is an audible alarm device.

7. The system of claim 6, wherein the audible alarm device being operable to emit an audible tone alerting of damage to the bridge.

8. The system of claim 6, wherein the audible alarm device being operable to emit a message alerting of damage to the bridge.

9. The system of claim 1, wherein the notification device is a warning light.

10. The system of claim 1, wherein the warning device is a drop bar.

11. The system of claim 1, wherein the signal comprises a sequence of signals being understood to be a notification of damage to the bridge.

12. The system of claim 1 further comprising a communication module coupled to the control panel, wherein the control panel is further operable to activate the communication module to notify a central operator of damage to the bridge upon failing to detect the return electric current on the second conductor, the communication module being operable to transmit a notification of damage to the bridge.

13. The system of claim 12, wherein the notification of damage comprises a wired communication.

14. The system of claim 12, wherein the notification of damage comprises a cellular communication.

15. The system of claim 12, wherein the notification of damage comprises a satellite communication.

16. The system of claim 12, wherein the notification of damage comprises a radio communication.

17. The system of claim 12, wherein the central operator is at a location remote from the bridge.

18. The system of claim 12, wherein the notification comprises a display of a warning message on a communication device accessible by the central operator.

19. The system of claim 12, wherein the notification comprises an audible warning suitable for emission on a communication device accessible by the central operator.

20. The system of claim 12, wherein the notification comprises an activation of at least one light on a communication device accessible by the central operator.

21. The system of claim 1, further comprising:
a third conductor and a fourth conductor suitable for carrying electric current, the third and fourth conductors suitable for running along a second section of the bridge;
a second junction box affixed to the second section of the bridge, the second junction box coupling a first end of the third conductor and a first end of the fourth conductor; and
wherein, the control panel is coupled to a distal end of the third conductor and a distal end of the fourth conductor, the control panel being operable to provide an electric current on the third conductor and to monitor the fourth conductor for an expected return electric current, the control panel being operable to transmit the signal to activate the notification device upon failing to detect the return electric current on the fourth conductor.

22. The system of claim 1, wherein the first section of the bridge comprises at least a portion of a deck of the bridge.

23. The system of claim 1, wherein the first section of the bridge comprises at least a portion of a guard rail of the bridge.

24. The system of claim 1, wherein the first section of the bridge comprises at least a portion of an abutment of the bridge.

25. The system of claim 1, wherein the first section of the bridge comprises at least a portion of a column of the bridge.

26. A method for monitoring a spanning structure for damage comprising:
running a first conductor along a first section of a spanning structure, the first conductor suitable for carrying electric current;
running a second conductor along the first section of the spanning structure, the second conductor suitable for carrying electric current;
coupling a first end of the first conductor and a first end of the second conductor;
supplying an electric current to a distal end of the first conductor;
monitoring the distal end of the second conductor for an expected return electric current; and
responsive to failing to detect the expected return electric current at the distal end of the second conductor, activating a notification device.

27. The method of claim 26, wherein the first end of the first conductor and the first end of the second conductor is coupled using a resistor.

28. The method of claim 26, wherein the first conductor and the second conductor are housed in a solid conduit when run along a physical portion of the first section of the spanning structure and housed in a flexible conduit when run along a portion of the first section of the spanning structure where expansion or contraction is expected to occur.

29. The method of claim 26, wherein the first conductor and the second conductor are each a copper wire.

30. The method of claim 26 further comprising:
running a third conductor along a second section of the spanning structure, the third conductor suitable for carrying electric current;
running a fourth conductor along the second section of the spanning structure, the fourth conductor suitable for carrying electric current;
coupling a first end of the third conductor and a first end of the fourth conductor;
supplying an electric current to a distal end of the third conductor;
monitoring the distal end of the fourth conductor for an expected return electric current; and
responsive to not detecting the expected return electric current at the distal end of the fourth conductor, activating the notification device.

31. The method of claim 26, wherein activating the notification device comprises displaying a message on a signboard.

32. The method of claim 26, wherein activating the notification device comprises emitting an audible alarm.

33. The method of claim 26, wherein activating the notification device comprises emitting an audible message.

34. The method of claim 26, wherein activating the notification device comprises displaying at least one warning light.

35. The method of claim 26, wherein activating the notification device comprises lowering a drop bar.

36. The method of claim 26 further comprising, responsive to failing to detect the expected return electric current at the distal end of the second conductor, notifying a central operator of damage to the spanning device.

37. The method of claim 36, wherein the central operator notifies emergency personnel of damage to the spanning device.

38. The method of claim 36, wherein the central operator remotely activates the notification device.

39. The method of claim 26, wherein the spanning structure is a bridge.

40. The method of claim 26, wherein the spanning structure is an overpass.

41. A spanning structure damage detection and warning system comprising:
a means for providing a closed circuit along a section of a spanning structure;
a means for supplying an electric current on the closed circuit;
a means for detecting a break in the closed circuit; and
a means for activating a notification device upon detecting the break in the closed circuit.

42. The system of claim 41 further comprising a means for notifying a central operator upon detecting the break in the closed circuit.
